(19) United States
(12) Patent Application Publication
(10) Pub. No.: US 2010/0276928 A1
(43) Pub. Date: Nov. 4, 2010

(54) Tube Tightening Structure of Music Instruments

(76) Inventor: Ming Yi Chang, Taichung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/177,609

(22) Filed: Jul. 22, 2008

(51) Int. Cl. F16L 25/00

(52) U.S. Cl. 285/420

(57) ABSTRACT

A tube tightening structure of a music instrument is disclosed. A plastic body is provided inside a metal hollow shell. The body has a through hole for the insertion of a tube. The body has an extension part that has a tightening part. A threaded element is connected with a rotating element outside the shell. The rotation of the rotating element displaces the threaded element, so that the tightening part tightly holds the tube in the through hole of the body.

### BACKGROUND OF THE INVENTION

1. Field of Invention

The invention relates to a tube tightening structure and, in particular, to a tightening structure for a retractable tube of a music instrument.

2. Related Art

As shown in FIGS. 7 and 8, a conventional tube tightening structure has a solid body 90 made of a zinc aluminum (Zn—Al) alloy. The body 90 has a through hole 901 for the insertion of a tube. A plastic ring 91 is provided at the through hole 901 of the body 90. The ring 91 has a contractible wing part 911. The body 90 has an extension part 902 by the ring. A tightening part 92 is provided in the extension part 902. A threaded element 93 is used to position the tightening part 92 at one end of the extension part 902. The other end of the extension part 902 is mounted with a butterfly nut 94. The threaded element 93 is mounted with an elastic element 95 on both ends, urging against the inner wall of the extension part 902 and the tightening part 92. One can turn the butterfly nut 94 to displace the tightening part 92, tightly snapping or letting go of the wing part 911 of the ring 91.

As described above, the Zn—Al body 90 is solid and therefore costs and weighs more. It is thus crucial to provide a solution to reduce the production cost and weight while maintaining sufficient strength.

### SUMMARY OF THE INVENTION

An objective of the invention is to provide a tube tightening structure that has a plastic body in a metal hollow shell. Therefore, the disclosed tube tightening structure has a sufficiently strong shell that does not easily deform. Since its interior is replaced by a plastic material, the production cost is lower than the conventional tube tightening structure. Moreover, it has a lighter weight.

To achieve the above-mentioned objective, the invention includes:
a plastic body, which has a through hole for the insertion of a tube, the through hole having a large-diameter section and a small-diameter section, wherein the small-diameter section of the through hole has an extension part sideways;
a metal shell, which is hollow and has a shape corresponding to the plastic body for accommodating it; and
a threaded element, whose one end is connected with a rotating element that displaces the threaded element as it rotates and whose other end drives a tightening part that snaps the tube in the small-diameter section of the through hole.

### BRIEF DESCRIPTION OF THE DRAWINGS

The invention will become more fully understood from the detailed description given herein below illustration only, and thus is not limitative of the present invention, and wherein:

FIG. 1 is a three-dimensional perspective view of the invention;

FIG. 2 is a three-dimensional exploded view of the invention;

FIG. 3 is a cross-sectional view of the interior of the invention;

FIG. 4 is a cross-sectional view showing how the tube is held;

FIG. 5 is a three-dimensional exploded view of the second embodiment;

FIG. 6 is a cross-sectional view of the structure in the second embodiment;

FIG. 7 is a three-dimensional perspective view of a conventional tube tightening structure; and

FIG. 8 is a cross-sectional view showing how the tube is held in the conventional tube tightening structure.

### DETAILED DESCRIPTION OF THE INVENTION

The present invention will be apparent from the following detailed description, which proceeds with reference to the accompanying drawings, wherein the same references relate to the same elements.

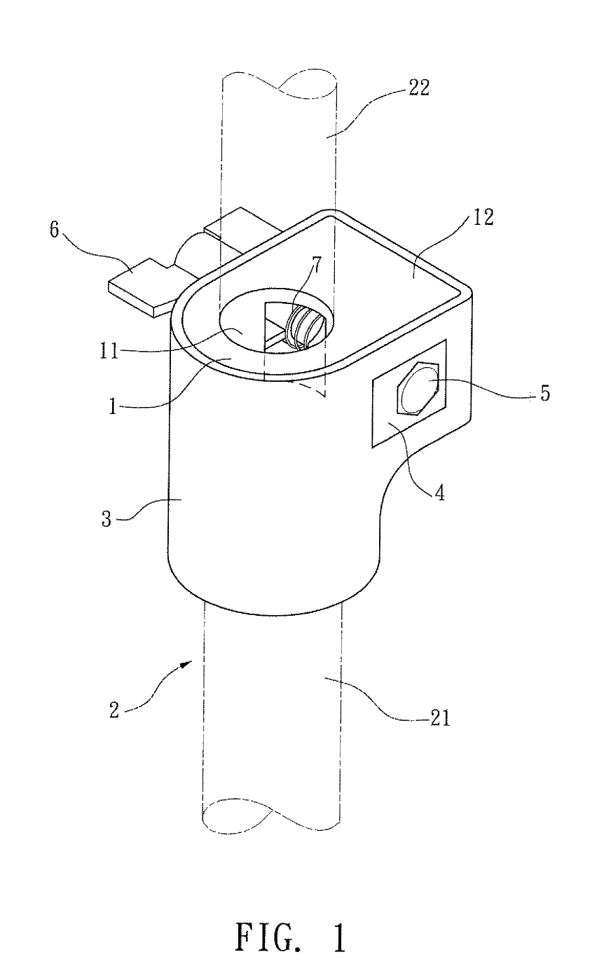

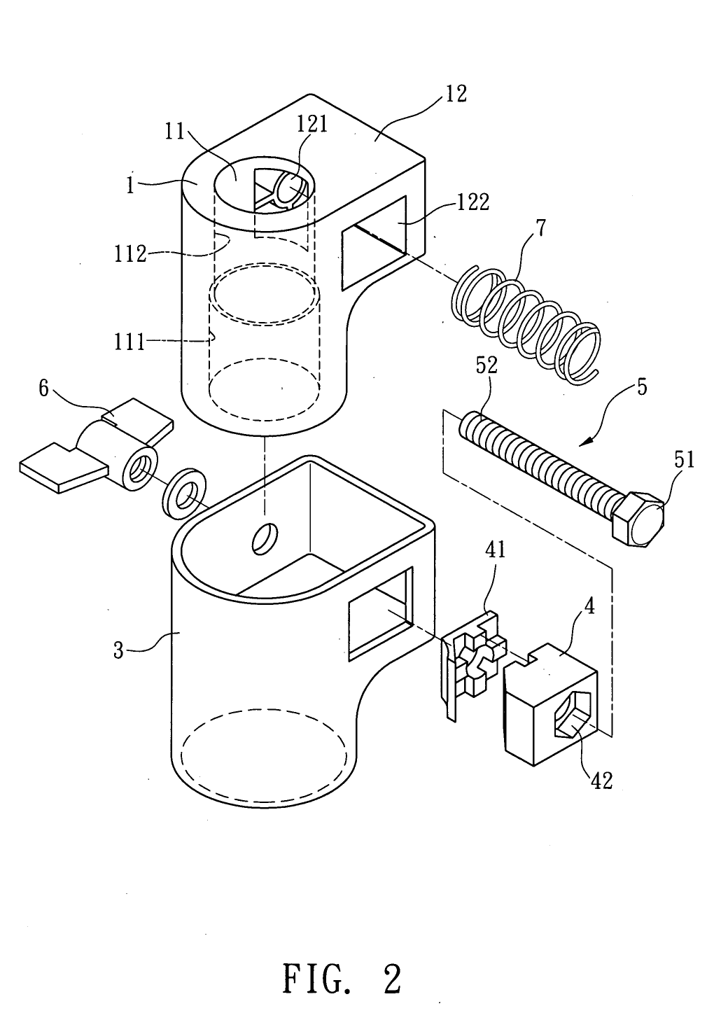

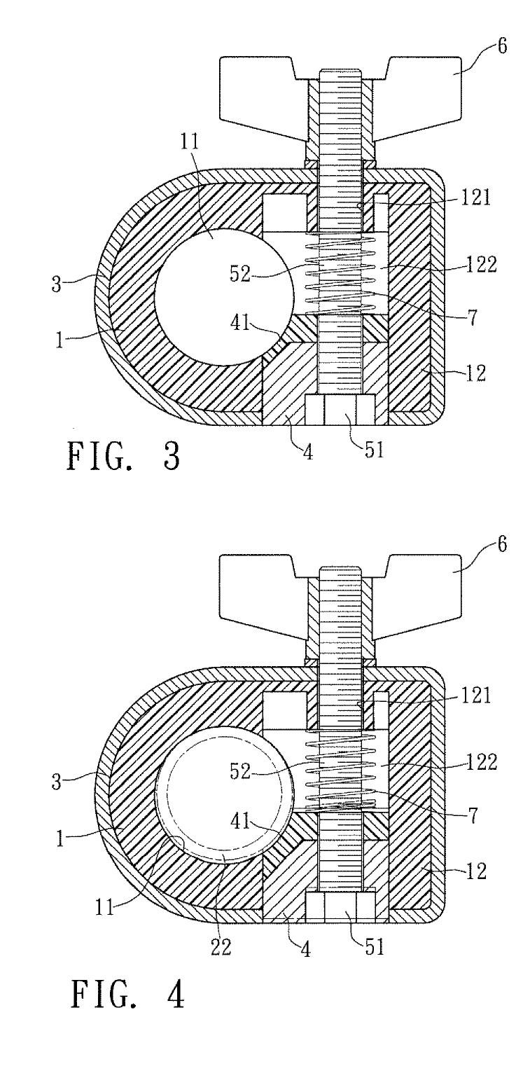

FIGS. 1 to 4 show a first embodiment of the invention. In this embodiment, the tube tightening structure of a music instrument includes: a body 1, a shell 3, and a threaded element 5.

The body 1 is made of a plastic material. It has a through hole 11 for the insertion of the tube 2 of a music instrument. The through hole 11 has a large-diameter section 111 and a small-diameter section 112. The large-diameter section 111 holds and fixes a hollow tube 21. The interface between the large-diameter section 111 and the small-diameter section 112 also allows the insertion of the tube 22 of the music instrument. The tube 22 in the small-diameter section 112 is smaller than the tube 21 in the large-diameter section 112. The tube 22 in the small-diameter section 112 can extend into the tube 21 in the large-diameter section 111 and adjust its length. An extension part 12 extends from the side of the small-diameter section 112 of the through hole 11 of the body 1.

The shell 3 is made of a metal material. It is hollow and has a shape corresponding tot that of the body 1 for accommodating it. In this embodiment, the body 1 and the shell 3 are connected using an adhesive.

In this embodiment, a hole 121 is formed on the side of the extension part 12 of the body 1. The hole 121 goes through the shell 3 and the body 1. A groove part 122 is formed on the opposite side from the shell 3 toward the body 1. The groove part 122 is connected with the through hole 11 and the hole 121.

Outside the shell 3, the threaded element 5 is connected by one of its ends with a rotating element 6 that displaces the threaded element 5 when it rotates. The other end of the threaded element 5 drives a tightening part 4 that holds the tube 22 tightly in the small-diameter section 112 of the through hole 11 in the body 1.

In this embodiment, the tightening part 4 is provided in the groove part 122. On the side facing the groove part 122, there is a holding part 41 made of a plastic material. The threaded element 5 is connected with the tightening part 4 by one end in the groove 122 of the body 1. The other end penetrates through the hole 121 and connects with the rotating element 6. The rotating element 6 urges against the outer wall of the shell 3. An elastic element 7 is mounted on the threaded element 5 in the groove part 122. The elastic element 7 urges against the inner wall of the groove part 122 by its one end. The other end urges against the holding part 41 of the tightening part 4. The elastic element 7 is a compressible spring.

In this embodiment, the threaded element 5 is an outer hexagonal screw. The opposite of the holding part 41 on the tightening part 4 has an inner hexagonal hole 42. The inner hexagonal hole 42 is slightly smaller than the head 51 of outer threaded element 5 (an outer hexagonal screw). The thread part 52 of the outer threaded element 5 (outer hexagonal screw) goes through the tightening part 4. Its head portion 51 is embedded into the inner hexagonal hole 42 and thus positioned therein. The rotating element 6 is a butterfly nut having an inner thread part 61. The outer thread part 52 of the outer threaded element 5 (outer hexagonal screw) matches with the inner thread part 61 of the rotating element 6.

According to the above-mentioned structure, the tightening part 4 makes a displacement in the groove part 122 as the rotating element 6 rotates. As the rotating element 6 screws in, the outer threaded element 5 (outer hexagonal screw) connected with the rotating element 6 drives the tightening part 4 to move toward the extension part 12. When the holding part 41 of the tightening part 4 enters the through hole 11, the holding part 41 touches against the external tube 22. The tube 22 is thus held tightly by the holding part 41 and the inner wall of the through hole 11 on the opposite side. The small-diameter section 112 of the tube 22 can be tightly fixed on the body 1. Since the holding part 41 is made of a plastic material, it does not scratch the surface of the tube 22 when it is held tightly. On the other hand, when the rotating element 6 screws out, the tightening part 4 moves outward in the groove part 122. Once the holding part 41 leaves the tube 22, the tube 22 is separate from the body 1. In this case, one can freely adjust the height of the tube 22 in the small-diameter section.

Therefore, in comparison with the conventional tube tightening structure, the invention provides a metal shell 3 mounted on the plastic body 1. The structure now uses less metal, but still maintains a good structural strength. Therefore, the tube tightening structure has a lighter weight. Moreover, the cost is much reduced.

It should be mentioned that when the rotating element 6 drives the tightening part 4 to hold the tube 22, the metal shell 3 prevents the extension from deformation. However, when the holding force on the tube 22 is small so that one does not need to worry about the strength of the extension part 12, the plastic body 1 alone can be used with other components than the shell 3. In that case, the weight is smaller and the production cost is cheaper. This is another advantage of the invention.

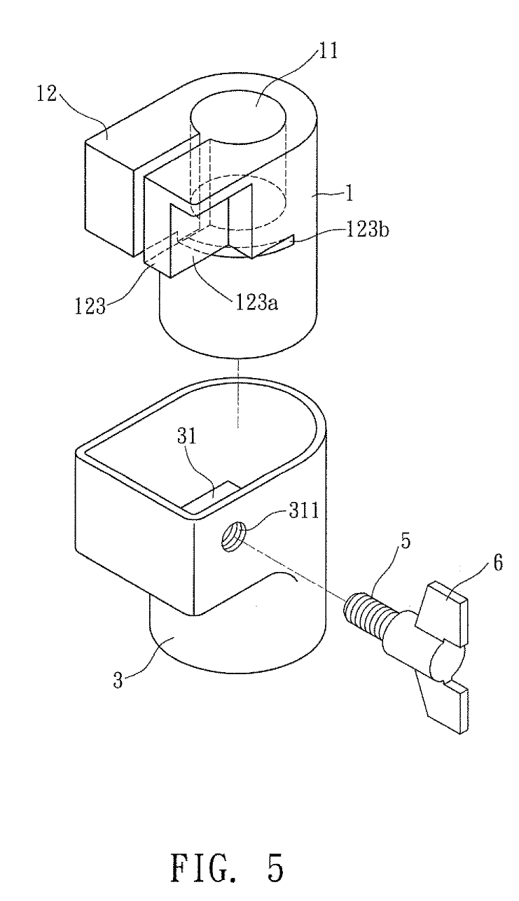

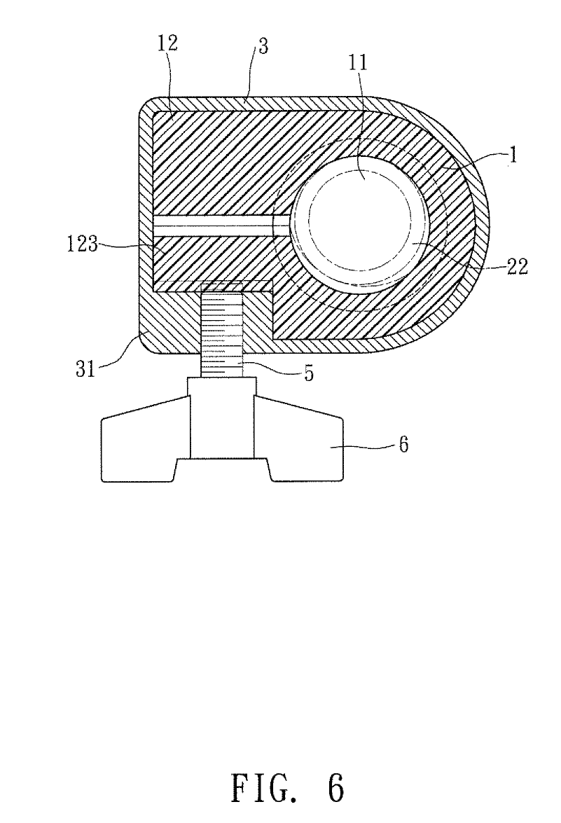

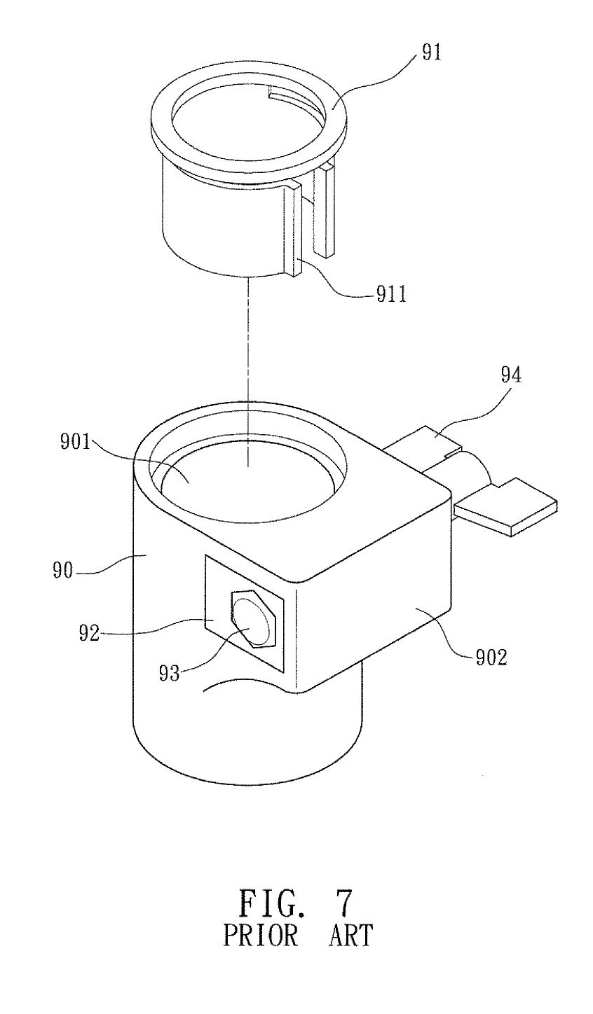

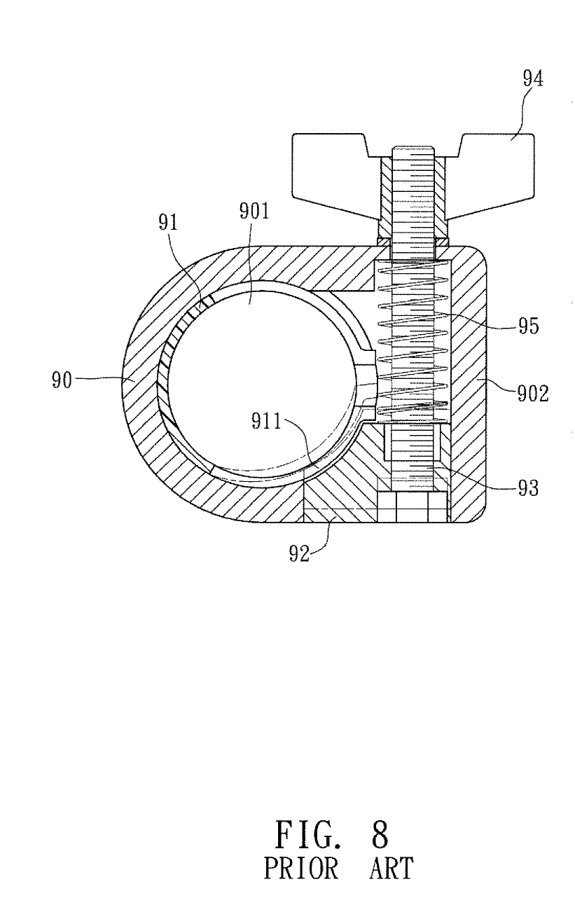

There are of course many other embodiments of the invention that only differ from the embodiment disclosed herein in some details. Please refer to FIGS. 5 and 6 for a second embodiment of the invention. The tightening part 123 extends from the extension part 12 of the body. The tightening part 123 has a concave part 123a. The tightening part 123 at the bottom of the body 1 has a horizontal cutting groove 123b for it to flexibly bend toward the through hole. The shell 3 has a protruding part 31 corresponding to the concave part 123a of the body 1. An inner thread part 311 for the outer threaded element 5 is provided in the protruding part 31. The outer threaded element 5 urges against the inner wall of the concave part 123a on the tightening part 123 of the body by its one end.

In this embodiment, the rotating element is a butterfly nut. It is fixed on one end of the outer threaded element 5 outside the shell 3.

Therefore, the structure in this embodiment can achieve the same effect as the tube tightening structure in the first embodiment.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A tube tightening structure of a music instrument, comprising:
a plastic body, which has a through hole for the insertion of a tube, the through hole having a large-diameter section and a small-diameter section and an extending part being formed sideways on the small-diameter section of the through hole;
a metal shell, which is hollow and has a shape corresponding to the body for accommodating it therein; and
an outer threaded element, whose one end is connected with a rotating element outside the shell for displacing the outer threaded element as it rotates and whose other end drives a tightening part that holds the tube tightly inside the small-diameter section of the through hole.

2. The tube tightening structure of a music instrument as in claim 1, wherein the body has a hole going through the shell and the body on the side of the extension part, a groove part connected with the through hole and the hole, the groove part accommodates the tightening part, the tightening part has a plastic holding part on the side facing the groove part, the outer threaded element is connected with the tightening part by one end inside the groove part and connected with the rotating element outside the hole by its other end, the rotating element urges against the outer wall of the shell, and an elastic element is mounted on the outer threaded element in the groove part with one end urging against the inner wall of the groove part of the body and the other end pushing against the holding part of the tightening part.

3. The tube tightening structure of a music instrument as in claim 2, wherein the outer threaded element is an outer hexagonal screw, an inner hexagonal hole slightly smaller than the head portion of the outer hexagonal screw is formed on the side of the tightening part opposite to the holding part, the outer threaded part of the outer hexagonal screw goes through the tightening part with its head portion embedded in the inner hexagonal hole and positioned therein, the rotating element is a butterfly nut having an inner threaded part, and the outer threaded part of the outer hexagonal screw and the inner threaded part of the rotating element match with each other.

4. The tube tightening structure of a music instrument as in claim 2, wherein the elastic element is a compressible spring.

5. The tube tightening structure of a music instrument as in claim 1, wherein the tightening part is extended from the extension part of the body, a concave part is formed on the tightening part, a horizontal cutting groove is formed at the extension portion of the tightening part at the bottom of the body for it to flexibly bend toward the through hole, the shell has a protruding part that is accommodated inside the concave part of the body, the protruding part has an inner threaded part for the outer threaded element to connect, and one end of the outer threaded element urges against the inner wall of the concave part on the tightening part of the body.

6. The tube tightening structure of a music instrument as in claim 5, wherein the rotating element is a butterfly nut fixed on an end of the outer threaded part outside the shell.

7. The tube tightening structure of a music instrument as in claim 1, wherein the body and the shell are fixed using an adhesive.
